(19) United States
(12) Patent Application Publication
(10) Pub. No.: US 2022/0295777 A1
(43) Pub. Date: Sep. 22, 2022

(54) PEST CAPTURE APPARATUS AND METHOD

(71) Applicant: STV INTERNATIONAL LIMITED, Thetford Norfolk (GB)

(72) Inventor: Edwin ALLINGHAM, Thetford (GB)

(21) Appl. No.: 17/641,549

(22) PCT Filed: Sep. 9, 2020
(86) PCT No.: PCT/GB2020/052167

§ 371 Date: Mar. 9, 2022

(30) Foreign Application Priority Data
Sep. 10, 2019 (GB) 1913055.8

(51) Int. Cl. A01M 23/08; A01M 23/16

(52) U.S. Cl. CPC A01M 23/08; A01M 23/16

(57) ABSTRACT

A pest trap comprising a pest-trapping portion (4) and a holder (14) for a bait for attracting a pest. The pest-trapping portion (4) is arranged between a first opening (6) through which the pest may enter the pest-trapping portion (4) and a second opening (8) which is closable. The trap is arrangeable in either of two modes. In a first mode, for familiarising pests to the trap, the second opening (8) is open and the pest can approach bait in the holder (14) without entering the pest-trapping portion (4). In a second mode, for trapping or killing pests, the second opening (8) is closed and the pest can approach the bait by entering the pest-trapping portion (4) through the first opening (6).

A method is provided for trapping the pest using the pest trap, by placing the trap in a position for trapping the pest, setting the trap in the first mode, and then switching the trap to the second mode.

The invention relates to an apparatus and a method for capturing or killing pests, and in particular rodents such as rats.

### BACKGROUND

Many pests, and in particular rodents such as rats, are nervous of new objects. This behaviour has evolved as a survival mechanism which protects the animals from hazards in their environment, but causes a significant problem when attempts are made to control pest numbers by trapping or killing. For example, if a conventional rat trap is deployed, a user may place the trap in a position which is frequented by rats such as next to a wall, and an attractive bait may be placed in the trap, but the rats' fear of new objects tends to keep them away from the trap.

### SUMMARY OF INVENTION

The invention provides a pest trap and a method as defined in the appended independent claims, to which reference should now be made. Preferred or advantageous features of the invention are set out in dependent subclaims.

Traps embodying the invention may be of various kinds. For example, the trap may be an electronic trap of the type described in patent publication WO 95/33372 A1, U.S. Pat. No. 6,836,999 B2 or U.S. Pat. No. 7,010,882 B2. Such traps typically comprise a pest-trapping portion in the form of a tunnel in which two electrodes form part of the floor. The pest is attracted into the tunnel by bait and when the pest is detected standing on the electrodes, a high voltage is applied to the electrodes to rapidly kill the pest.

Alternatively, a trap may comprise a pest-trapping portion which is simply closable to trap the pest alive, for example by means of a spring-loaded closure which is tripped by the pest entering the pest-trapping portion. Other traps may use mechanical or other means to kill the pest entering the pest-trapping portion.

In a first aspect the invention may provide a pest trap comprising a pest-trapping portion and a holder for a bait for attracting the pest. The pest may be a rodent, such as a rat or a mouse. The pest-trapping portion is arranged between a first opening through which a pest may enter the pest-trapping portion and a second opening which is closable by a user. Bait is placed in the bait holder and the trap may then be arranged in either of two modes. In a first mode, which may be for familiarising pests to the trap, the second opening is open and the pest may easily approach bait in the holder without entering the pest-trapping portion. In a second mode, for trapping or killing pests, the second opening is closed and the pest can approach the bait by passing through the first opening and entering the pest-trapping portion. The pest may then be killed or trapped in the pest-trapping portion as in a conventional trap.

The second opening may be closable to restrict access by the pest therethrough. This may be to prevent any access by the pest through the second opening, or it may be to allow limited access, or partial access, to the bait through the closed opening as described further below.

In this way, when the trap is switched to the second mode and the second opening is closed, the pest has already become familiar with the trap and is not deterred (by its fear of new objects) from approaching the bait in the holder by entering the pest-trapping portion through the first opening.

In a preferred embodiment, the trap may for example comprise a door or other closure for closing the second opening. The door or closure preferably comprises or is made from a pest-resistant material.

In the first mode of operation of the trap (the familiarisation mode), in a preferred embodiment the door may be open and the trap baited to attract pests, in order to familiarise the pests with the trap. In this mode, there is a danger that the pests may gnaw or otherwise damage the open door or closure. It is therefore desirable that the door or closure is made of a material or materials that are resistant to damage. For example, using a pest-resistant material may prevent the pest from eating, gnawing or otherwise damaging the door. For example, the door may comprise or be made from metal. Preferably the door may comprise or be made from wire mesh. The mesh should comprise a sufficiently large gauge of wire to resist damage by gnawing.

In the second mode of operation of the trap (the pest-trapping mode), the door may seal or partially seal the second opening.

The door or closure may be perforated. For example, it may comprise one or more holes or perforations through which light, and/or odours from the bait, may pass. Preferably the door is perforated so that it may provide a line of sight from the first opening through a perforation or perforations in the door when the second opening is closed. For example, when the trap is in its second (pest-trapping) mode with the second opening closed, the perforation(s) in the door may allow light to pass through, thus providing the pest with a line of sight from the first opening through the trap and the perforations in the door. This line of sight, and the pest being able to see light through the trap, may encourage the pest to enter the pest-trapping portion.

When the second opening is closed (with the trap in its second mode), the pest may advantageously be able to smell or see the bait, or even to consume at least some of the bait, through the perforation or perforations in the door. This may maintain the pest's interest in the trap even after the second opening is closed, and even if the pest has not yet entered the pest-trapping portion. Access to the bait should be somewhat limited by the door so the pest may be induced or encouraged to enter the trap by the first opening to fully access the bait. In this embodiment it is particularly important that the door is of a pest-resistant material, to prevent the pest from damaging the door in an attempt to access the bait.

The door or closure may be openable and closable by pivoting about a substantially vertical hinge. Therefore, when the door is open, with the trap in its first (familiarisation) mode, the pest may access the bait with minimal interaction with other parts of the trap. For example, the pest may access the bait without standing on any part of the trap.

If the door or closure is openable and closable by pivoting about a horizontal hinge at the bottom of the door, then the door would lie horizontally on the ground when the door is open. A pest may then be able to access bait in a holder on the door or at an entrance to the second opening, but the pest would need to stand on, or walk or reach over the door to access the bait. However, the aim of the invention is to provide a trap which overcomes neophobia in pests, and so it is clearly disadvantageous if the pest needs to stand on or reach over the door to reach the bait. It is greatly preferred for the pest to be able to reach the bait with as little difficulty as possible, keeping its feet on familiar ground at all times.

The door or closure could be openable and closable about a horizontal hinge at the top of the second opening, or about a hinge at some other angle or position. Such arrangements may be used if they allow easy access for the pest to the bait, but if the door opens upwards then the pest may need to pass beneath the door in order to reach the bait. Again, this arrangement would not be ideal to overcome neophobia.

The door may comprise the holder for bait. Alternatively, the holder for bait may be positioned within or adjacent to the second opening; for example if the pest-trapping portion is in the form of a tunnel, then the holder may be within the tunnel, preferably near the second opening.

The holder for bait may hold, during use of the trap, a solid bait such as a bait block, which fits within or engages with the holder. For example, the holder may be in the form of a cage, such as a metal or wire mesh cage, and solid bait such as a bait block or blocks may be retained by the cage. Pests may then be able to access the bait through openings in the cage.

Alternatively, or in addition, the holder for bait may comprise a rod or bar for, during use of the trap, retaining perforated bait blocks by passing through a perforation in one or more bait blocks.

Therefore, one or more bait blocks may be held by the holder for the bait, such that the pest may be able to access and eat the bait in or on the holder but so that the holder prevents the pest from removing the bait block from the trap. It is important during the first, familiarisation, mode of the trap that the pest cannot consume the bait too quickly, and that the pest cannot remove the bait from the holder and consume it elsewhere. The aim of the familiarisation mode is to encourage the pests to be attracted to and interested in the trap, so the bait must remain in place in the holder. The holder should therefore be resistant to damage by the pests, for example being made of metal or wire of sufficiently large gauge.

If, for example, loose bait were provided in a conventional trough then the pests may eat it too quickly, or may be able to remove it from the trough and to take it away from the trap.

When the second opening is open the pest can advantageously easily approach bait in the holder without passing through the first opening, and preferably without passing through any other portion of the trap. For a pest which is nervous of new objects in its environment, such as the trap, this may allow the pest to approach and even eat the bait as easily and directly as possible. In this way, the presence of the trap disturbs the pest as little as possible and the pest can become familiar with the trap. The pest may even become encouraged to approach the trap in order to eat the bait.

In one embodiment, access to the bait through the second opening is blocked completely when the second opening is closed, and bait in the holder can be approached by the pest only by entering the pest-trapping portion through the first opening.

In another embodiment, access to the bait through the second opening is only partially blocked when the second opening is closed. This may increase the spread of odour from the bait and so encourage the pest to approach the trap but nevertheless, when the second opening is closed, access to bait in the holder through the second opening is restricted so as to encourage the pest to approach the bait through the first opening rather than the second opening.

In a preferred embodiment, in the first (familiarisation) mode a pest-trapping functionality of the trap is disabled, or turned off, and in the second (trapping) mode the pest-trapping functionality of the trap is enabled, or turned on. In a particularly-preferred embodiment, opening the second opening automatically disables, or turns off, the pest-trapping functionality of the trap.

The trap may comprise a switch which is operable on opening the second opening automatically to disable the pest-trapping portion of the trap. Preferably, the switch is not damageable by the pest. For example, the switch may be made from metal, to prevent the pest from eating the switch. Alternatively, or in addition, the switch may not be accessible to the pest when the second opening is open, for example the switch may be located in a hinge of the door or closure.

The pest-trapping portion of the pest trap may comprise electrodes for administering a high voltage to the pest within the pest-trapping portion for killing the pest.

When the pest-trapping portion of the pest trap comprises electrodes it may be of particular value for the trap to comprise the switch to automatically disable the pest-trapping portion of the trap. This is because of the danger of electric shocks to a user of the trap when the second opening is open, when for example a user's fingers may be able to touch the electrodes.

In a preferred embodiment, the second opening may be openable to insert bait into the trap, and it is then particularly desirable that an electronic trap is switched off when the second opening is open.

The pest trap may comprise a closing means for closing the second opening. The closing means may be manually operated or it may be automatic. The closing means may be actuatable in response to a timer for closing the second opening after the trap has been in the first mode for a predetermined time. Or the closing means may be actuatable in response to a control input from an operator. Or, the trap may comprise a pest detector for detecting pests approaching the trap in the first mode, and for actuating the closing means for closing the second opening after detection of a threshold level of pest activity, such as the detection of a predetermined number of pests, or of approaches by pests to the trap, or of a predetermined frequency of visits by pests to the trap. This may reduce the need for an operator to attend the trap to inspect for signs of pest activity.

A manual closing means may for example comprise a spring-loaded door which is easily closable by an operator, with minimal disturbance to the trap as it is switched from the first mode to the second.

The door may be held open when the trap is in its first mode. This may limit or prevent accidental closure of the second opening, for example by the pest moving around the door and exploring the bait. The door may be held open by a small protrusion on the base of the door. The small protrusion may rest on a surface, such as the ground, below the trap to ensure that the second opening remains held open when in the first mode. Alternatively, the door may be held open by a door stay. The door stay may comprise a wire or rod. For example, a first end of the wire may be in contact with the pest-trapping portion and a second end of the wire may be in contact with the door. Or, the door may be held open by a spring or equivalent mechanism, such as a spring-loaded cam or lever. This may be an over-centre spring or equivalent mechanism acting on the door to hold it in either its open position or its closed position, an operator being able to move, or switch, the door between these positions against the action of the spring.

The pest trap may further comprise a holder for water. The water holder may be positioned adjacent to or near the bait holder to form a feeding station. The presence of water in the holder may encourage the pest to return to the bait. The water holder may be in the form of a receptacle or tray attached to, or moulded as, part of the door. Or, the water holder may be formed or moulded as an end part of the floor of the pest-trapping portion.

A further aspect of the invention relates to a method for using a trap as described. The method may advantageously comprise the steps of setting the trap in the first mode and placing the trap in a position for trapping a pest for a period of time, to familiarise the pest to the trap; and then switching the trap to the second mode, preferably leaving it in the same position, for trapping or killing the pest.

Thus it may be advantageous to be able to switch the trap from the first mode to the second mode, and (if required) to switch the trap on, without moving the trap. If the switch from the first mode to the second mode only involves closing a door over the second opening, then this may advantageously minimise disturbance to the trap as the switch is made. This may maximise the effect of the previous familiarisation of the pest to the trap, as the trap may not be seen by the pest as a new object if it has not moved or been disturbed.

### PREFERRED EMBODIMENTS OF THE INVENTION

Preferred embodiments of the invention will now be described by way of example, with reference to the accompanying drawings, in which:

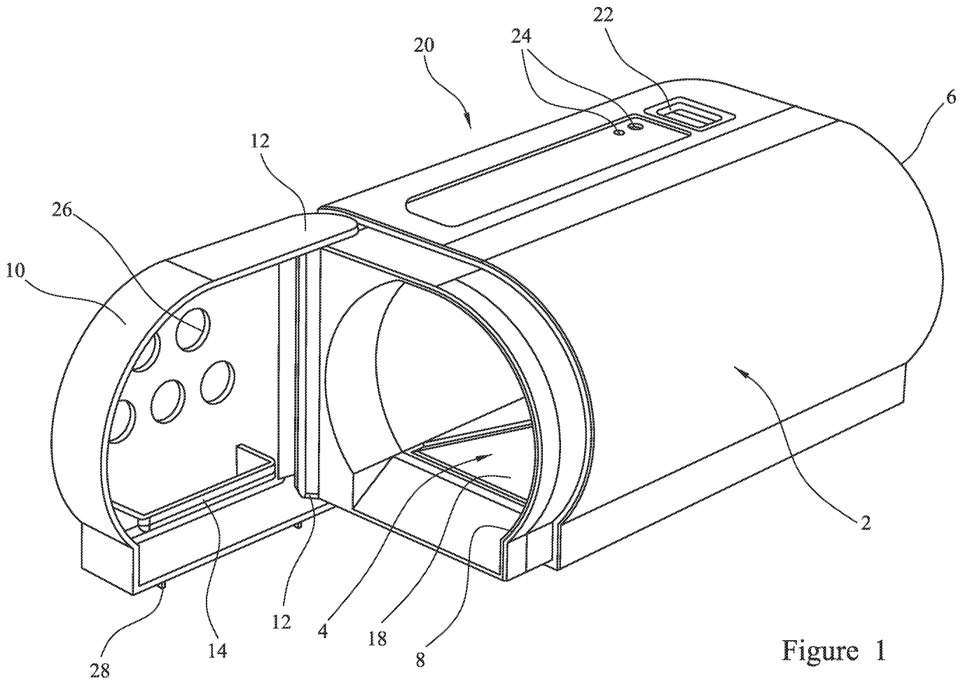

FIG. 1 is a three-quarter view of a trap according to a first embodiment of the invention, in a pest-familiarisation mode;

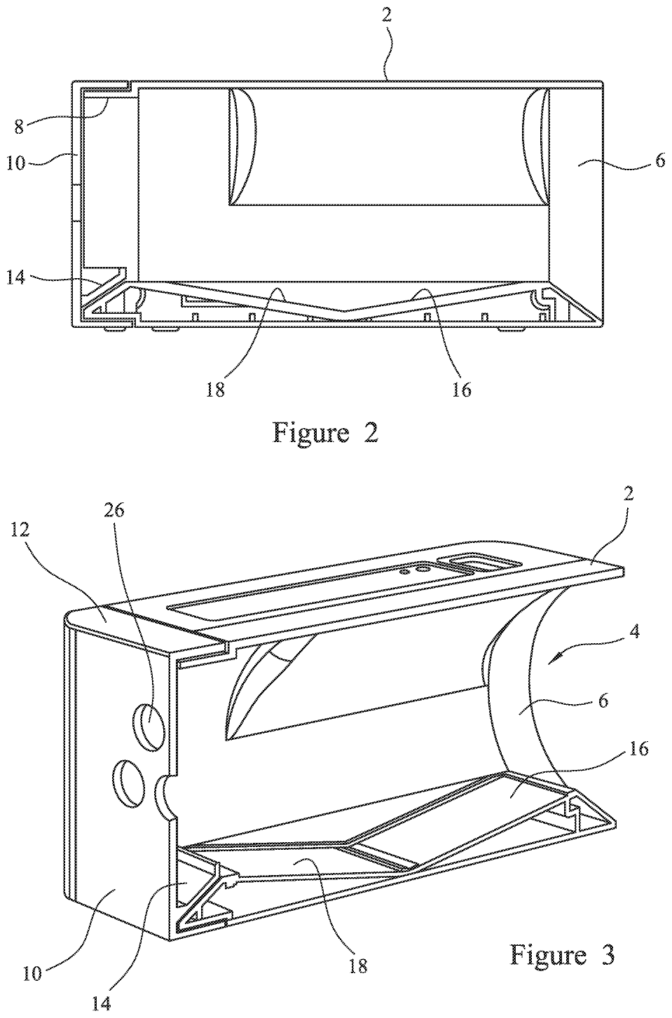

FIG. 2 is a longitudinal section of the trap of the first embodiment, in a pest-trapping mode;

FIG. 3 is a three-quarter view of the longitudinal section of FIG. 2;

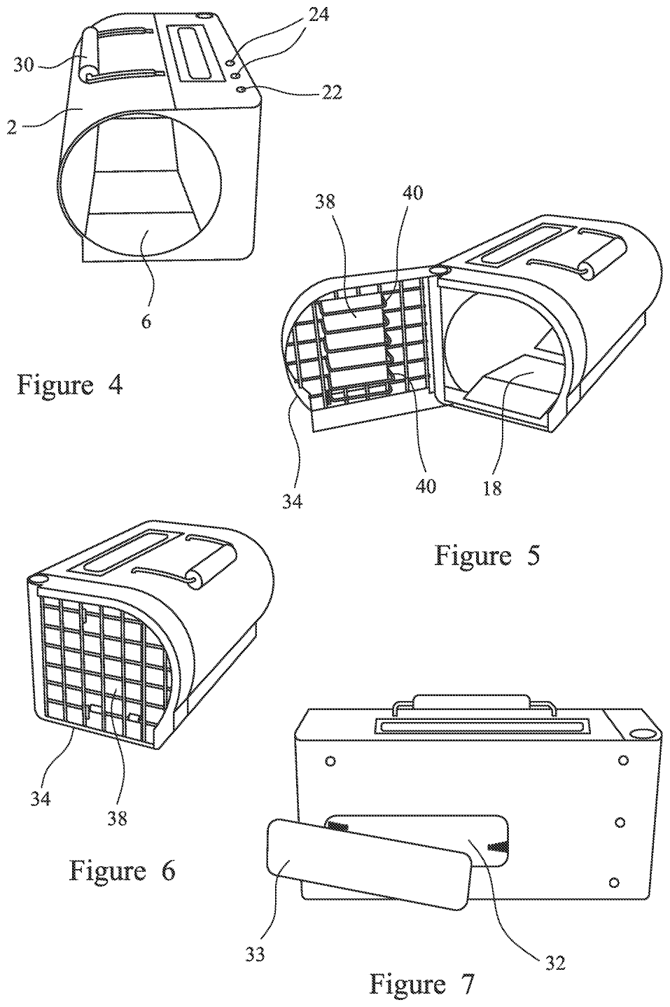

FIG. 4 is an end view of a trap according to a second embodiment of the invention, from a first end of the trap and in a pest-trapping mode;

FIG. 5 is a three-quarter view of the trap of the second embodiment, from a second end of the trap and in a pest-familiarisation mode;

FIG. 6 is a three-quarter view of the trap of the second embodiment, from a second end of the trap and in a pest-trapping mode;

FIG. 7 is a rear view the trap of the second embodiment, in a pest-trapping mode;

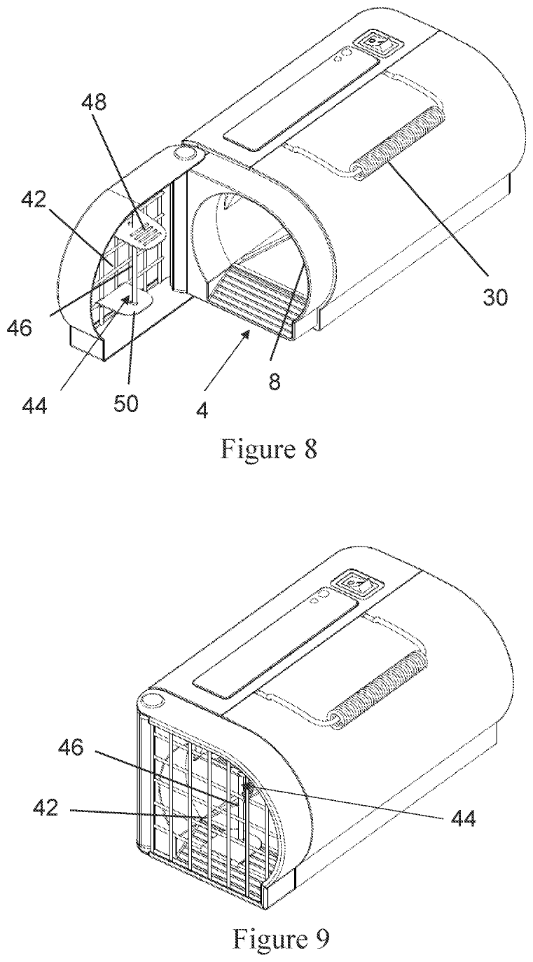

FIG. 8 is a three-quarter view of a trap according to a third embodiment, in pest-familiarisation mode; and

FIG. 9 is a three-quarter view of the trap of the third embodiment, in pest-trapping mode.

FIGS. 1 to 3 illustrate a rodent trap according to a first embodiment of the invention. This trap is an electronic trap for killing rats.

The trap comprises a moulded plastics housing 2 within which is defined a pest-trapping portion 4 in the form of a tunnel between a first opening 6 and a second opening 8 at opposite ends of the tunnel. The second end of the tunnel is closable by a door 10 mounted on substantially vertical hinges 12, which can be swung open as shown in FIG. 1 or latched closed as shown in FIGS. 2 and 3.

The door carries a holder 14 for bait, on the surface of the door which faces the tunnel when the door is closed.

A base of the tunnel comprises two electrodes 16, 18, slightly spaced apart from each other. The electrodes are coupled to battery-powered electronic circuitry housed within the housing to one side 20 of the tunnel. In a pest-trapping mode, the door 10 is closed and a rat may enter the tunnel (the pest-trapping portion) through the first opening 6 attracted by bait in the holder 14. When the pest is standing on both electrodes, the electronics detects the electrical resistance of the rat and applies a high voltage (a killing voltage) to the electrodes for a predetermined period of time to kill the rat. The dead rat can then be disposed of.

An upper surface of the housing provides a location for an on-off switch 22 and LEDs 24 to signal to a user when the trap is switched on.

A plurality of ventilation holes or perforations 26 are defined through the thickness of the door 10. These holes provide a line of sight from the first opening through the second opening when the second opening is closed. These holes are too small to allow a rat to access or approach the bait, but allow an airflow through the tunnel to disperse the odour of the bait, so as to attract rats into the pest-trapping tunnel.

Operation of the trap is as follows.

A user ensures that the trap is switched off, and opens the door 10 about the vertical hinge. The user places bait in the bait holder 14 and, leaving the door open, they place the trap in a suitable place to catch rats, such as near a wall in a location where rats are a problem. Small protrusions 28 below the base of the door rest on the ground and ensure that the door remains open, held by the weight of the trap. This prevents the movement of rats around the door from accidentally closing the door. The trap is left in this position for a period of time, such as a few hours, or a day, so that rats are attracted by the bait and can approach the trap. Because the rats can access the bait while standing on the ground and without entering the pest-trapping portion (or tunnel) 4, they are less deterred from approaching the trap and the attraction of the bait may be sufficient to cause them to approach the trap. During this time, the rats become familiar with the trap, and they become less nervous or frightened of it.

After this familiarisation process, the user closes the door 10, optionally replenishing the bait at the same time, without moving the trap. The user also switches on the trap using the switch 22. The door may be provided with an electrical interlock or switch, which on opening the door automatically disables the pest-trapping portion of the trap, to prevent the trap from being switched on until the door is closed.

Closing the door closes the second opening 8 of the pest-trapping portion so that rats can only approach the bait through the first opening 6. The ventilation holes or perforations in the door help to disperse the odour of the bait and attract the rats. When a rat approaches the first opening the perforations also provide a line of sight from the first opening through the perforations in the closed door, encouraging the rat to enter the trap. When a rat enters through the first opening and is detected by the electrodes, the high killing voltage is applied to kill the rat. The rat can then be disposed of and the trap reset.

FIGS. 2 and 3 show the bait holder 14 in position at an end of the pest-trapping portion. In this embodiment, the bait holder is in the form of a receptacle or tray attached to or moulded as part of the door. In an alternative embodiment the bait holder may be of similar form, but moulded as an end part of the floor of the pest-trapping portion. It would then be in the same position as shown in FIGS. 2 and 3 when the door is closed, but would remain in this position at the end of the pest-trapping portion when the door is opened.

FIGS. 4 to 7 illustrate a trap according to a second embodiment of the invention. The structure of this trap is similar to that of the first embodiment, except as described below. The same reference numerals are used as in FIGS. 1 to 3 to identify like components. The trap of FIGS. 4 to 7 comprises a carrying handle 30 on the top of the housing, and on the rear of the housing as shown in FIG. 7 there is provision to insert batteries into a battery holder 32 beneath a cover 33 to power the electronics.

The door 34 of the trap of FIGS. 4 to 7 differs from that of FIGS. 1 to 3 in that it is made from a pest-resistant wire mesh 36 within a metal frame. The wire mesh provides perforations in the door which provide a line of sight through the trap when the second opening is closed. The door supports a preformed solid block 38 of bait within a wire receptacle 40 on the side of the door which is inside the pest-trapping portion 4 when the door is closed. The wire receptacle prevents the pests from removing the bait block(s) from the trap and carrying them away to eat elsewhere.

Preferably, the casing of the trap is also made from metal or other pest-resistant material.

The metal and wire mesh door has the advantage that rats cannot gnaw it, either while the door is open in the familiarisation mode of the trap, or to gain access to the bait when the door is closed. Because of the open nature of the mesh, rats may have limited access to the bait even when the door is closed, but the openings in the mesh are small enough to restrict their access to the bait through the mesh, so that they can only satisfactorily access the bait from within the pest-trapping portion. They are therefore attracted into the trap through the first opening and can be killed by the high voltage.

The trap of the second embodiment may be supplied to the user with a bait block already in place in the bait holder, and additional bait blocks may be available for sale as required. During the familiarisation process pests may freely access the bait, and so replacement bait blocks may be required more often than in a conventional trap.

In a preferred embodiment, the trap comprises a closing mechanism coupled to the hinge that is actuatable to close the door in response to a timer and/or a detector, such as an optical or proximity detector for detecting the presence of pests, or for counting pests approaching the trap. During use, the trap is initially left in the familiarisation mode, with the door open. After a predetermined time or after detection of a predetermined level of pest activity, the door is closed by the closing means, automatically switching the trap into the pest-trapping mode.

FIGS. 8 and 9 illustrate a pest trap according to a third embodiment of the invention. The structure of the trap is similar to the second embodiment of the invention, except as described below. The same reference numerals are used as in FIGS. 4 to 7 to identify like components.

The door 42 of the trap of FIGS. 8 and 9 is similar to that of FIGS. 4 to 7, in that it is made from a wire mesh within a metal frame, or from other pest-resistant materials. However, the bait holder 44 of the trap of FIGS. 8 and 9, differs from that of FIGS. 4 to 7. The bait holder 44 comprises a rod 46 for retaining preformed perforated bait blocks. During use, the rod 46 passes through a perforation in a bait block to engage with the bait. The rod is secured at its upper and lower ends by upper and lower tabs 48, 50 which extend from the door. The upper end of the rod is pivotably retained by the upper tab 48 and the lower end of the rod engages with a hole in the lower tab 50. To place bait on the rod, the upper tab 48 is flexed upwards, withdrawing the lower end of the rod from the hole in the lower tab 50. Bait blocks are then placed on the rod, and the lower end of the rod reinserted into the hole in the lower tab 50.

In use, the bait retained on the rod 46 is easily accessible to the rat and the rat can eat the bait without having to eat through or around parts of the bait holder 44 or other parts of the trap as is the case with the bait-retaining cage of the second embodiment. The rod 46 retains the bait blocks so the rat is not able to remove the bait from the trap to consume it elsewhere. The bait holder 44 is on the side of the door which is inside the pest-trapping portion 4 when the door is closed, so that when the door is closed the pest is encouraged to enter the pest-trapping portion of the trap to access the bait. The door 42 is openable about a vertical hinge, as in the first and second embodiments. The hinge comprises an over-centre spring so that the door is positively retained by the spring in either the open or closed positions. Therefore, when the door is open in the familiarisation mode of the trap, the spring holds the door in the open position as shown in FIG. 8. When a user closes the door, against the action of the over-centre spring, the spring holds the door in the closed position as shown in FIG. 9.

The hinge further comprises an interlock or switch which disables the electric pest-trapping mechanism when the door is open. Locating the interlock in the hinge ensures that it cannot be damaged by pests.

1. A pest trap comprising a pest-trapping portion and a holder for a bait for attracting a pest, the pest-trapping portion being arranged between a first opening through which the pest may enter the pest-trapping portion and a second opening which is closable, the trap being arrangeable in either of two modes;
in which in a first mode, for familiarising pests to the trap, the second opening is open and the pest can approach bait in the holder without entering the pest-trapping portion and in a second mode, for trapping or killing pests, the second opening is closed and the pest can approach the bait by entering the pest-trapping portion through the first opening.

2. A pest trap according to claim 1, comprising a door for closing the second opening, the door comprising a pest-resistant material.

3. A pest trap according to claim 2, in which the door is made from metal, and preferably from wire mesh.

4. A pest trap according to claim 2, in which the door is perforated, preferably to provide a line of sight from the first opening through a perforation or perforations in the door when the second opening is closed.

5. A pest trap according to claim 4, in which, during use of the trap, the pest can access the bait through the perforation or perforations in the door when the second opening is closed.

6. A pest trap according to claim 1, in which the door is openable and closable about a substantially vertical hinge.

7. A pest trap according to claim 1, in which the door comprises the holder for bait.

8. A pest trap according to claim 1, in which the holder for bait is positioned within or adjacent to the second opening.

9. A pest trap according to claim 1, in which the holder is for holding, during use of the trap, a solid bait such as a bait block, which fits within or engages with the holder.

10. A pest trap according to claim 9, in which the holder comprises a rod for, during use of the trap, retaining perforated bait blocks by passing through a perforation in one or more bait blocks.

11. A pest trap according to claim 1, comprising a switch which is operable on opening the second opening automatically to disable the pest-trapping portion of the trap.

12. A pest trap according to claim 1, in which the pest-trapping portion comprises electrodes for administering a high voltage to the pest within the pest-trapping portion for killing the pest.

13. A pest trap according to claim 1, comprising a closing means for closing the second opening.

14. A pest trap according to claim 13, in which the closing means is actuatable in response to a timer for closing the second opening after the trap has been in the first mode for a predetermined time;
or in which the closing means is actuatable in response to a control input from an operator;
or in which the trap comprises a pest detector for detecting pests approaching the trap in the first mode, and for actuating the closing means for closing the second opening after detection of a threshold level of pest activity.

15. A method for trapping a pest using a trap as defined in claim 1, comprising the steps of;
placing the trap in a position for trapping the pest, setting the trap in the first mode for familiarising pests to the trap; and then switching the trap to the second mode for trapping or killing the pest.
